(19) United States
(12) Patent Application Publication
(10) Pub. No.: US 2011/0088785 A1
(43) Pub. Date: Apr. 21, 2011

(54) SAFETY FEATURE FOR STUCK VALVE

(75) Inventor: Kishore Balasubramanian, Bloomington, MN (US)

(73) Assignee: Eaton Corporation, Cleveland, OH (US)

(21) Appl. No.: 12/582,768

(22) Filed: Oct. 21, 2009

(51) Int. Cl. F16K 17/00

(52) U.S. Cl. 137/1; 137/455

(57) ABSTRACT

A method for controlling a safety feature for a hydraulic machine is provided. The method includes detecting when at least control valve for a controller of an implement for the hydraulic machine is stuck in a position. An exhaust valve for the hydraulic control system is then moved to a closed position to prevent movement of the implement of the hydraulic machine.

### TECHNICAL FIELD

The invention relates to a hydraulic control system, and more particularly, to a control valve safety feature for the hydraulic control system

### BACKGROUND OF THE INVENTION

Hydraulic systems for heavy equipment, such as excavators, backhoes, bulldozers, front end loaders, earthmovers, etc., typically use hydraulic controls to manipulate implements of the equipment. For example, hydraulic controls are used to manipulate the load basket for front end loaders. The hydraulic control system includes multiple control valves to provide for manipulation of each sub-system of the implement separately. Additionally, each sub-system may include multiple control valves to thereby control the movement of the implement. Therefore, the hydraulic control system typically includes multiple control valves for controlling multiple features of each implement.

### SUMMARY OF THE INVENTION

A method for controlling a hydraulic control system is provided. The method includes detecting a condition in which at least one control valve for a controller of an implement for the hydraulic fluid control system is stuck in an open position. An exhaust valve for the fluid control system is then moved to a closed position.

A method for controlling a safety feature for a hydraulic machine is provided. The method includes detecting when at least one control valve of a first rod controller, a first head controller, a second rod controller, or a second head controller of a fluid control system for the hydraulic machine is stuck in a position. An exhaust valve for the fluid control system is then moved to a closed position to prevent movement of a sub-assembly of the hydraulic machine.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a general perspective illustration of an embodiment of construction equipment utilizing a hydraulic control system;

FIG. 2 is a schematic illustration of a piston and cylinder for the construction equipment of FIG. 1;

FIG. 3 is a schematic illustration of a first embodiment of a hydraulic control system for the construction equipment of FIG. 1; and

FIG. 4 is an enlarged schematic illustration of a portion of the first embodiment of the hydraulic control system of FIG. 2.

### DESCRIPTION OF THE PREFERRED EMBODIMENTS

Referring to the drawings, wherein like reference numbers refer to like components, FIG. 1 illustrates a piece of construction equipment 10, such as but not limited to, an excavator, a backhoe, a bulldozer, an earth mover, etc. The construction equipment 10 includes at least one implement 12. In the embodiment shown the construction equipment 10 is a front end loader and the implement 12 is a lift basket. The equipment 10 includes a hydraulic control system 14 for manipulating the implement 12. The implement 12 may include multiple sub-assemblies requiring independent control to manipulate the implement 12. In the embodiment shown, the multiple sub-assemblies for the equipment 10 include a first piston assembly 16 for tilting the implement 12 and a second piston assembly 18 for lifting the implement 12. In the embodiment shown the sub-assemblies are utilized for lifting and tilting the implement 12. However, other sub-assemblies for different purposes in manipulating the implement 12 may be utilized depending on the type of equipment 10 that the hydraulic control system 14 is utilized with.

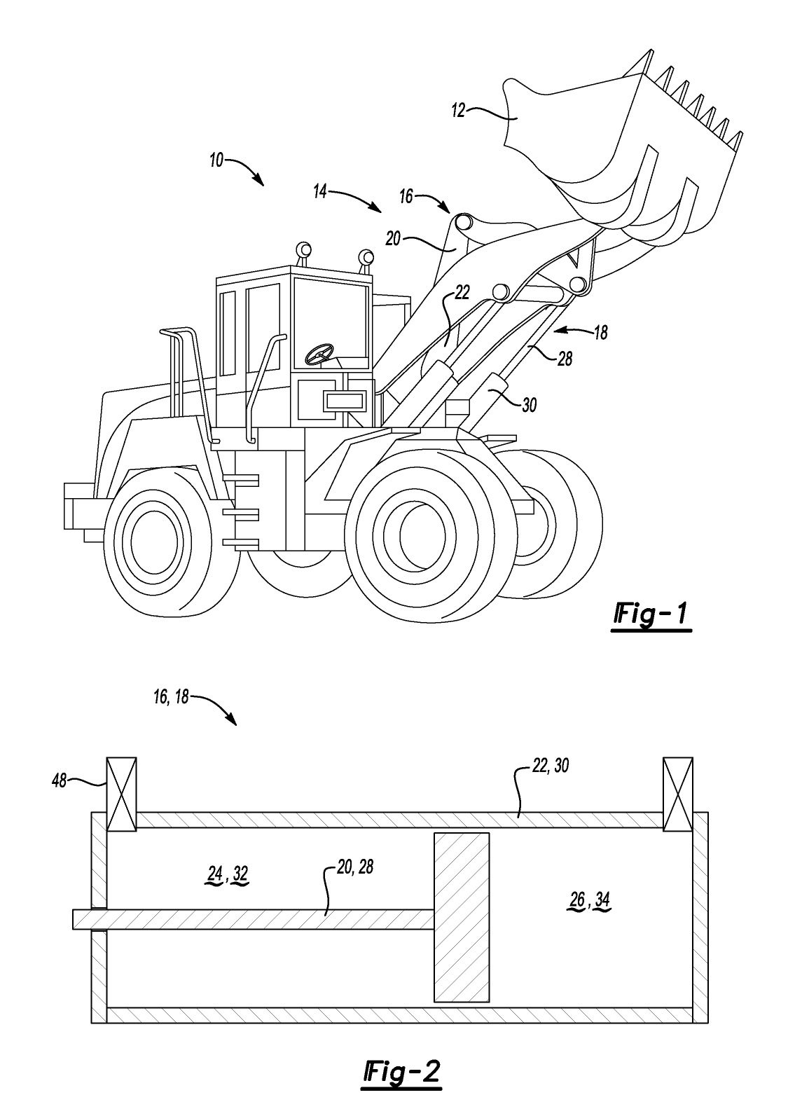

Referring to FIGS. 1 and 2, the first piston assembly 16 includes a first piston 20 and cylinder 22. The first piston 20 and the first cylinder 22 define a first rod chamber 24 and a first head chamber 26. Likewise, the second piston assembly 18 includes a second piston 28 and a second cylinder 30. The second piston 28 and the second cylinder 30 define a second rod chamber 32 and a second head chamber 34. The hydraulic control system 14 individually controls fluid flow to the first rod chamber 24, first head chamber 26, second rod chamber 32 and the second head chamber 34.

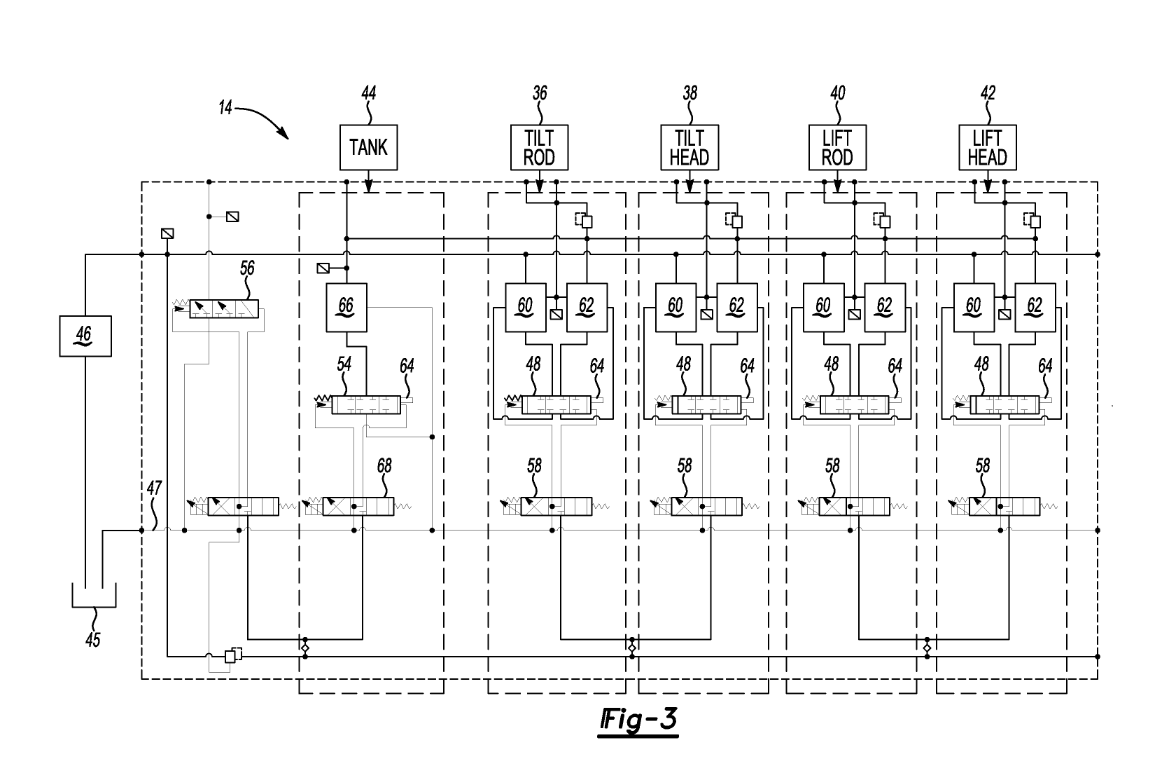

Referring to FIGS. 2 and 3, an embodiment of the hydraulic control system 14 is explained. The hydraulic control system 14 includes a first rod controller 36 to control the flow of fluid with respect to the first rod chamber 24. A first head controller 38 controls the flow of fluid with respect to the first head chamber 26. A second rod controller 40 controls the flow of fluid with respect to the second rod chamber 32. Finally, a second head controller 42 controls the flow of fluid with respect to the second head chamber 34.

The first rod controller 36, first head controller 38, second rod controller 40 and the second head controller 42 are arranged in parallel with one another. Operation of the first rod controller 36 and the first head controller 38 may be coordinated with one another due to the corresponding positions of the controllers on opposing ends of the first piston assembly 16. Likewise, operation of the second rod controller 40 and the second head controller 42 may be coordinated with one another due to the corresponding positions of the controllers on opposing ends of the second piston assembly 18.

A variable displacement supply pump 46 moves the fluid from a supply tank 45 to the first rod controller 36, first head controller 38, second rod controller 40, and second head controller 42. The supply pump 46 and the flow of fluid to the first rod controller 36, first head controller 38, second rod controller 40, and the second head controller 42 are controlled by a main supply valve 56. A tank controller 44 controls the flow of return fluid from the first rod controller 36, first head controller 38, second rod controller 40 and the second head controller 42 through a hydraulic return line 47 back to the supply tank 45.

The tank controller 44 includes an electrically controlled tank pilot valve 68, a hydraulically controlled middle-stage pilot valve 54 and a hydraulically controller tank poppet valve 66. The tank pilot valve 68 adjusts the tank middle-stage pilot valve 54 which in turn adjusts the tank poppet valve 66 to control the return of fluid to the supply tank 45 from the first rod controller 36, first head controller 38, second rod controller 40, and the second head controller 42. Together the tank pilot valve 68 and the tank middle-stage pilot valve 54 provide a two-stage control of return fluid to the tank 45.

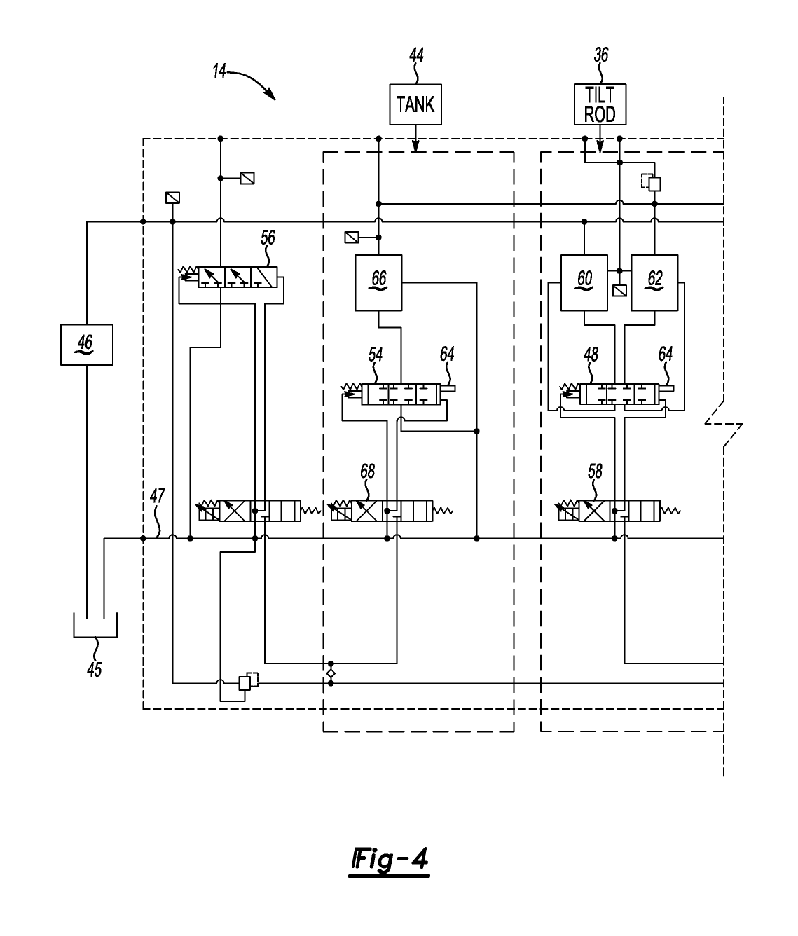

Referring to FIG. 4, an enlarged view of a portion of the hydraulic control system 16 shown. Operation of the hydraulic control system 16 is explained with respect to the first rod controller 36 although the first head controller 38, second rod controller 40 and the second head controller 42 operate in a similar manner.

The first rod controller 36 includes a middle-stage pilot valve 48 a main stage poppet valves 60 and 62 which control the flow of fluid into and out of the first rod chamber 24. The middle-stage pilot valve 48 is a variable valve which is hydraulically controlled by a pilot valve 58. The pilot valve 58 controls the position of the middle-stage pilot valve 48 to adjust the fluid flow into the first rod chamber 24. The pilot valve 58 is electrically controlled by the first rod controller 36. Together the pilot valve 58 and the middle-stage pilot valve 48 provide a two-stage control of fluid flow for the first rod chamber 24.

During operation of the hydraulic control system 14 the first rod controller 36 may detect that the pilot valve 58, the middle-stage pilot valve 48 or the main stage poppet valves 60 and 62 are stuck. For example, the first rod controller 36 may detect the open position of the pilot valve 58, the middle-stage pilot valve 48, the main stage poppet valve 60, or the main stage poppet valve 62 through a valve position sensor 64. Other means and sensors for detecting an open position for the pilot valve 58, the middle-stage pilot valve 48, the main stage poppet valve 60, or the main stage poppet valve 62 may also be utilized.

If the pilot valve 58, the middle-stage pilot valve 48, the main stage poppet valve 60, or the main stage poppet valve 62 is stuck in position then the flow of fluid into and out of the first rod chamber 24 can not be controlled. While the first head controller 38 may still be operational, the position of the first piston assembly 16 (shown in FIGS. 1 and 2) can no longer be controlled. When the pilot valve 58, the middle-stage pilot valve 48, the main stage poppet valve 60, or the main stage poppet valve 62 for the first rod controller 36 cannot be adjusted the flow of fluid into or out of the first rod chamber 24 cannot be adjusted. This may create undesirable fluid flow between the first rod chamber 24 and the hydraulic return line 47 which may result in undesirable movement of the implement 12. The tank controller 44 is used to close the tank poppet valve 66 to ensure that any undesirable movement of the implement 12 does not occur. Closing the tank poppet valve 66 prevents the flow of fluid back to the tank 45. Therefore, flow of fluid from the hydraulic return line 47 to the tank 45 is blocked which in turn prevents the flow of fluid from the first rod chamber 24.

The closed tank poppet valve 66 prevents fluid from flowing out of the first rod chamber 24 to the tank 45. The closed tank poppet valve 66 prevents fluid from flowing from the first head chamber 26, second rod chamber 32, and second head chamber 34 back to the supply tank 45 as well. Therefore, closing the poppet valve 66 prevents undesirable movement of the implement 12 when the main stage pilot valve 58, the middle-stage pilot valve 48, the main stage poppet valve 60, or the main stage poppet valve 62 is stuck in position. Closing the tank poppet valve 66 provides an additional safety feature to prevent movement of the implement 12 until the pilot valve 48, the first spool valve 60, or the second spool valve 62 can be repaired.

As can be seen, the first head controller 38, second rod controller 40, and the second head controller 42 also each include a pilot valve 58, a middle-stage pilot valve 48, a main stage poppet valve 60, and a main stage poppet valve 62. Therefore, the first head controller 38, the second rod controller 40, and the second head controller 42 may each detect a stuck valve in a similar manner as that of the first rod controller 36. Additionally, if any of the pilot valve 58, the middle-stage pilot valve 48, the main stage poppet valve 60, or the main stage poppet valve 62 are stuck at the same time as another the pilot valve 58, the middle-stage pilot valve 48, the main stage poppet valve 60, or the main stage poppet valve 62 the tank controller 44 may close the tank poppet valve 66 in a similar manner.

While the best modes for carrying out the invention have been described in detail, those familiar with the art to which this invention relates will recognize various alternative designs and embodiments for practicing the invention within the scope of the appended claims.

1. A method for controlling a hydraulic control system comprising:
detecting a condition in which at least one control valve for a controller of an implement of the hydraulic control system is stuck; and
closing an exhaust valve for the hydraulic control system.

2. The method of claim 1, wherein the exhaust valve is a tank poppet valve, and wherein a tank controller controls the position of the tank poppet valve to control the flow of exhaust fluid to a supply tank for the hydraulic control system.

3. The method of claim 1, wherein the controller is one of a first rod controller, a first head controller, a second rod controller, and a second head controller; and wherein the at least one control valve is a valve for one of the first rod controller, a first head controller, a second rod controller, or a second head controller.

4. The method of claim 3, wherein the first rod controller controls the flow of fluid into and out of a first rod chamber, the first head controller controls the flow of fluid into and out of the first head chamber, the second rod controller controls the flow of fluid into and out of a second rod chamber, and the second head controller controls the flow of fluid into and out of a second head chamber.

5. The method of claim 4, wherein closing the exhaust valve prevents the flow of fluid from the first rod chamber, the first head chamber, the second rod chamber, and the second head chamber.

6. The method of claim 3, wherein the first rod controller, and the first head controller control a first piston sub-assembly and the second rod controller and the second head controller control a second piston sub-assembly.

7. The method of claim 1, wherein the at least one control valve is one of a pilot valve, a middle-stage pilot valve, a first main stage poppet valve, and a second main stage poppet valve and wherein the exhaust valve is a tank poppet valve.

8. A method for controlling a safety feature for a hydraulic machine comprising:
detecting a condition in which at least one control valve of one of a first rod controller, a first head controller, a second rod controller, and a second head controller of a fluid control system for the hydraulic machine is stuck; and
closing an exhaust valve for the fluid control system to prevent movement of a sub-assembly of the hydraulic machine.

9. The method of claim 8, wherein the first rod controller, and the first head controller control a first piston sub-assembly and the second rod controller and the second head controller control a second piston sub-assembly.

10. The method of claim 8, wherein the first rod controller controls the flow of fluid into and out of a first rod chamber, the first head controller controls the flow of fluid into and out of the first head chamber, the second rod controller controls the flow of fluid into and out of a second rod chamber, and the second head controller controls the flow of fluid into and out of a second head chamber.

11. The method of claim 10, wherein closing the exhaust valve prevents the flow of fluid from the first rod chamber, the first head chamber, the second rod chamber, and the second head chamber.

12. The method of claim 8, wherein the control valve is one of a pilot valve, a middle-stage pilot valve, a first main stage poppet valve, and a second main stage poppet valve, and wherein the exhaust valve is a tank poppet valve.

13. A hydraulic control system comprising:
at least one control valve to control the flow of fluid into and out of a chamber for an implement of the hydraulic control system;
an exhaust valve for the hydraulic control system hydraulically connected to the chamber to control the flow of fluid from the chamber back to a fluid supply tank;
a controller operable to control the at least one control valve, wherein the controller is operable to detect when the at least one control valve is stuck; and
wherein the exhaust valve is operable to move to a closed position when the at least one control valve is stuck to prevent the flow of fluid from the chamber to the supply tank.

14. The hydraulic control system of claim 13, wherein the controller is one of a first rod controller, a first head controller, a second rod controller, and a second head controller.

15. The hydraulic control system of claim 14, further comprising:
a first piston sub-assembly, wherein the first rod controller, and the first head controller are operably connected to control the first piston sub-assembly; and
a second piston sub-assembly, wherein the second rod controller and the second head controller are operably connected to control the second piston sub-assembly.

16. The hydraulic control system of claim 15, wherein the first piston sub-assembly further comprises a first rod chamber and a first head chamber, wherein the second piston sub-assembly further comprises a second rod chamber and a second head chamber, and wherein the chamber is one of the first rod-chamber, the first head chamber, the second rod chamber, and the second head chamber.

17. The hydraulic control system of claim 16, wherein the exhaust valve is a tank controller poppet valve, and wherein the tank controller poppet valve prevents the flow of fluid from the first rod chamber, the first head chamber, the second rod chamber, and the second head chamber back to the supply tank when the tank controller poppet valve is in the closed position.

18. The hydraulic control system of claim 15, wherein the first piston sub-assembly is a tilt piston assembly operable to tilt the implement and the second piston sub-assembly is a lift piston assembly operable to lift the implement.

19. The hydraulic control system of claim 13, wherein the control valve is one of a pilot valve, a middle-stage pilot valve, a first main stage poppet valve, and a second main stage poppet valve.

20. The hydraulic control system of claim 13, wherein the exhaust valve is a tank poppet valve.
